(19) United States
(12) Patent Application Publication
(10) Pub. No.: US 2007/0288274 A1
(43) Pub. Date: Dec. 13, 2007

(54) ENVIRONMENT AWARE RESOURCE CAPACITY PLANNING FOR SERVICE DELIVERY

(76) Inventors: Tian Jy Chao, Bedford, NY (US); Rajesh Jaluka, Poughkeepsie, NY (US); Santhosh Babu Kumaran, Peekskill, NY (US); David Matthew Loewenstern, New York, NY (US); Heiko Hary Ludwig, New York, NY (US); Ann M. Moyer, Woodstock, NY (US); Steven Matthew Weinberger, Lewis Center, OH (US)

Correspondence Address: CAHN & SAMUELS, LLP, 2000 P. STREET, NW, SUITE 200, WASHINGTON, DC, 20036, US

(21) Appl. No.: 11/422,119

(22) Filed: Jun. 5, 2006

(51) Int. Cl. G06F 9/44

(52) U.S. Cl. 705/7

(57) ABSTRACT

Disclosed is an apparatus and method for organizing a capacity planning system. The method includes receiving resource model data from a domain knowledge, receiving generic resource definitions from the domain knowledge, developing a service delivery center capacity model based upon the domain knowledge and other data. The method further includes implementing a capacity management platform to execute a capacity plan for processing the capacity management.

### FIELD OF THE INVENTION

The invention relates to the enablement of providing a rich model required to automate the composition of large-scale service offerings. by providing a set of standards for specifying relevant constraints and a data model for storing and propagating these constraints efficiently.

### BACKGROUND

The development of flexible, large-scale service offerings has been hampered by the inherent difficulties in coordinating component services, a problem that will only increase in importance as the economy becomes more service-oriented.

The problem of allocation, provisioning and re-provisioning of component services to compose a large-scale service offering can be regarded as an optimization problem across large numbers of constraints. There have been several attempts at automating this problem, but these have been less than successful. There has been difficulty in building a sufficiently rich model of the constraints on everything from network bandwidth to physical location and thus has prevented the automated construction of large-scale, real-world service offerings.

Others have tried different approaches for providing services, such as the following prior art.

U.S. Patent Application 2002/01 69649A1 discloses a method for automated and efficient provision of professional legal documents and services. The provision of legal forms to a user by a lawyer is facilitated over an electronic communications link. The method entails establishing a communications link to permit a lawyer to provide legal advice to a user, receiving payment for the legal advice based on user information, and restricting access by the lawyer to a portion of the user information to maintain anonymity. The method generates customized situation-specific legal documents directly to the user's computer, and it does so without the risk of conflicts of interest, thereby substantially simplifying and streamlining the rendering of legal advice to users. Immediate rich text format (rtf) document delivery is accomplished directly to a secondary browser window so that subscribers are free to modify the documents at will.

U.S. Patent Application 2004/0024627A1 discloses a Business Technology Relationship Model (BTRM) is a method for abstracting and modeling the relationships that exist between technical infrastructure components and specific business processes, resulting in a proprietary Business Technology Relationship Protocol. The method defines a dependency approach to technical infrastructure delivery and management by creating the 13 Layer BTRM Dependency/impact Hierarchy, a modeled understanding of the dependencies that specific business processes have on specific technical infrastructure components, including the interdependencies between modeled business and technical objects. When the resulting Relationship Protocol is placed into software, the BTRM Method improves the delivery and management of technology infrastructure and technology support services spanning a diverse set of industries and business disciplines.

U.S. Patent Application 2005/0203917A1 discloses a system and method designed to optimize the delivery of information on demand via wired or wireless connections. Dynamic information such as weather data can be delivered as compressed text, images, charts, buoy data, radar, GRIB files, and many more formats. Numerous continuously updated products can be delivered to a user of a client application on demand by the push of a button. The user can generate a batch folder having a list of data products to download. The data list in the batch folder can be requested from a server using a single command. The system and method can be configured to immediately connect to a server via a wireless connection or email, including satellite phone and HF/Pactor Radio, and downloads the requested data. After the download the client can be configured to automatically display the requested data.

U.S. Patent Application 2006/0069607A1 disclose tools and related methods for business organizations to quickly obtain, preserve and exploit new or improved assets, skills or capabilities that are important to growth and success. The tools and processes disclosed are adapted to preserve one or more target elements of an acquired target business organization by outsourcing those target elements during the integration period that follows the merger or acquisition. This outsourcing of one or more target elements during the integration period that necessarily follows a merger or acquisition deal creates various inherent advantages over the traditional merger, acquisition, or outsourcing approaches as described herein, and these advantages help to deliver benefits of the target element in speedy fashion and with undiminished quality.

U.S. Pat. No. 6,438,594 discloses a system, method, and article of manufacture are provided for delivering service via a locally addressable interface. A plurality of globally addressable interfaces and a plurality of locally addressable interfaces are provided. Access is allowed to a plurality of different sets of services from each of the globally addressable interfaces and the locally addressable interface. Each interface has a unique set of services associated therewith. The globally addressable interfaces are registered in a naming service for facilitating access thereto. Use of the locally addressable interfaces is permitted only via the globally addressable interfaces or another locally addressable interface.

### SUMMARY OF THE INVENTION

An exemplary feature of this invention is a method for organizing a capacity planning system, comprising: receiving resource model data from domain knowledge; receiving generic resource definitions from said domain knowledge; developing a service delivery center capacity model based upon said domain knowledge and other data; and implementing capacity management platform to execute a capacity plan for processing said capacity management.

Another exemplary feature of this invention is a method of receiving resource model data relating to a server.

A further exemplary feature of this invention is a method of receiving resource model data relating to a network.

Yet another exemplary feature of this invention is a method of receiving resource model data relating to a storage apparatus.

Still another exemplary feature of this invention is a method of receiving resource model data relating to a customer application.

Another exemplary feature of this invention is a method of receiving resource model data relating to a point of deployment for services.

A further exemplary feature of this invention is a method of receiving resource definitions based upon metrics data relating to resource model.

Another exemplary feature of this invention is a method of tying metrics data to the business function of the resource model.

Yet another exemplary feature of this invention is a method of imposing limits on the resource model.

Still another exemplary feature of this invention is a method of imposing limits defining an upper limit for the resource model.

A further exemplary feature of this invention is a method of imposing limits defining an imposed limit for the resource model.

Various other objects, features, and attendant advantages of the present invention will become more fully appreciated as the same becomes better understood when considered in conjunction with the accompanying drawings, in which like reference characters designate the same or similar parts throughout the several views.

### BRIEF DESCRIPTION OF THE DRAWINGS

FIG. 1 illustrates a resource model according to an embodiment of the present invention.

FIG. 2 illustrates a server acting as a resource according to an embodiment of the present invention.

FIG. 3 illustrates a network acting as a resource according to an embodiment of the present invention.

FIG. 4 illustrates an external storage apparatus acting as a resource according to an embodiment of the present invention.

FIG. 5 illustrates a customer application acting as a resource according to an embodiment of the present invention.

FIG. 6 illustrates a point of deployment acting as a resource according to an embodiment of the present invention.

FIG. 7 illustrates an usage scenario according to an embodiment of the present invention.

FIG. 8 illustrates a flow chart according to an embodiment of the present invention.

FIG. 9 illustrates a hardware implementation for services delivery according to an embodiment of the present invention.

FIGS. 10 and 11 illustrate a software deployment implementation services delivery according to an embodiment of the present invention.

FIGS. 12A, 12B and 12C illustrate still another software deployment implementation for services delivery according to an embodiment of the present invention.

### DETAILED DESCRIPTION

An embodiment of the present invention provides a rich model required to automate the composition of large-scale service offering by providing a set of standards for specifying relevant constraints and a data model for storing and propagating these constraints efficiently.

### RESOURCE DEFINITION

What is a Resource

In the context of this disclosure, a resource is any item within a given infrastructure for which a management tool needs to interact with on for or to in order to achieve some business objective.

Describing a Resource

Every resource is described by a set of corresponding properties, and a set of implemented operations that can be executed. The following diagram speaks to the properties of all resources as they relate to capacity planning, and infers the existence of certain operations.

Requirements for Definition of a Resource

Every discipline must identify their discipline specific properties

Properties definition must be done in a standard way.

Resource Model Definition:

The list that follows describes classification of resources:
IT Resources
   Application(infrastructure software), LPAR, Server, Cluster, Storage Location Site/Space
   Floor Space, Capacity, Personnel
Logical Resources
   Database Records, VLANs, IP Addresses, Configuration Files, Content Applications/Services (collection of infrastructure software configured for a specific purpose)
   Web Services

Generic Resource Definition

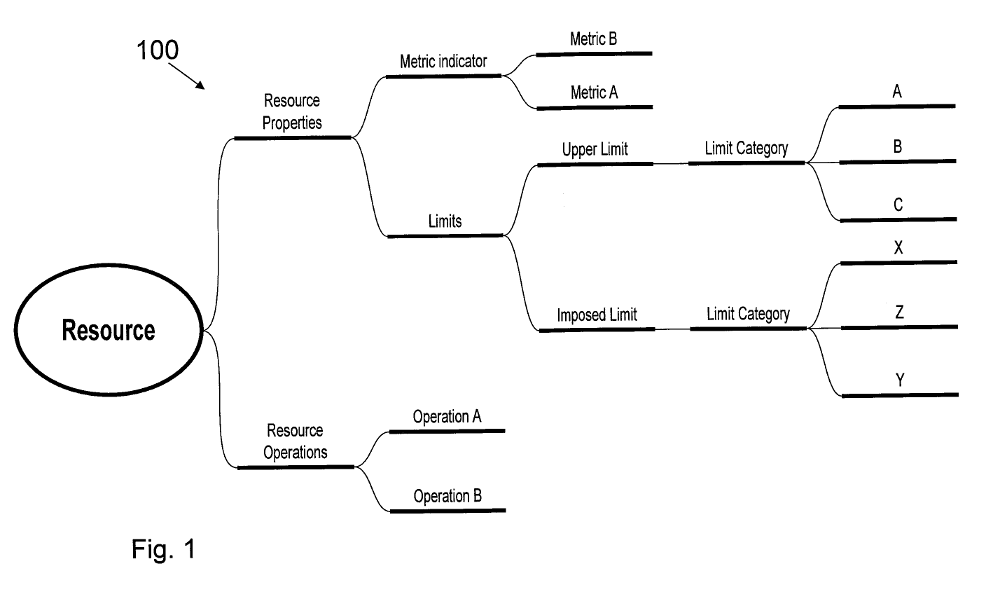

Referring to FIG. 1, shown is a resource model 100 that can be applied to Capacity Planning. The model 100 can be applied to all “resources” within a given environment. This model 100 is not limited for use as a data model, but in an embodiment of the present invention, can be used as a method to define the data that would need to be managed in order to manage the resources capacity in an automated fashion.

Resource Properties

Properties

A given resource may have many properties utilized by many different areas of systems management of which only certain categories are of interest from a Capacity Management viewpoint. In order to scope our discussion we will be limiting ourselves to the metric indicators and the limits of a given resource as well as discussing operations which can be taken to affect change on a given resource types capacity.

Capacity Specific Properties

Metric Indicators

Tied directly to the business function the given resource is intended to address, the metric indicators are aggregated/processed data which has been determine via “best practice” style research to be the best indicator of the current capacity threshold of a given resource.

Limits

Specific to each type of resource, a Limit can be of two types, imposed limits or upper limits. An imposed limit would be a limit that is lower than the Upper limit but is set by a governing process while an upper limit is the current resource's upper bounds in regards to its maximum capacity.

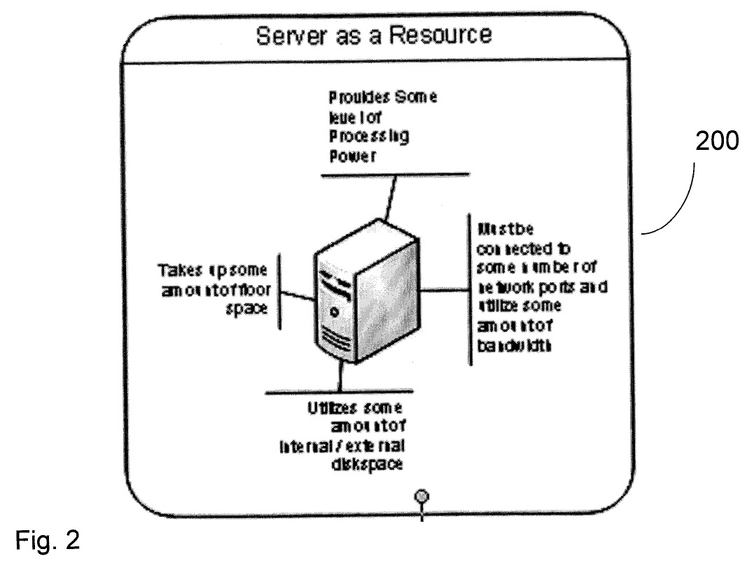

Referring to FIG. 2, shown is as a server acting a resource 200.

Using the above model we start first with a lower level IT resource 200, in this embodiment it is a server. Working through the methodology we would first determine what metrics could be used to trend the server's capacity and determine when capacity should be added or deleted. These metrics would be identified as the metric indicators for the server, and be used by a governing process to determine when a given operation for the server would be executed.

The operations for a given server denote what can be executed to affect a change in the current capacity for an instance of the given resource. These operations need to be orchestrated workflows but could include both manual and automated steps. Once these operations are known they would be documented as part of the resource definition as the Capacity management operations for the given resource.

The process consuming this information would continually be trending the capacity of the given service using the available metric indicators identified for the server type, as a trend towards a capacity limit is reached, the governing process would determine what could be done to change the capacity of the server. Depending on the trend this could be a positive or negative change in the available capacity of the server. In order to determine how much the capacity can be changed, the governing process would evaluate the process imposed limits on the resource as well the upper bounds of the resource capacity set by the manufacturer of the resource. If the process bounds are hit, an option is available to exceed the process bounds and proceed closer to the upper bounds, or to determine if a new server needs to be brought in to replace the existing server in order to increase the boundaries available for capacity management.

In some case limits may be inherited from another resource that the server is contained in, so there is a containment hierarchy that needs to be managed. In this case, the “Point of Deployment” imposes a limit on the ability to add a new server, if the floor space available at the PoD is not large enough to physically add a new server in that location.
Operations
   Physically Scale up/down Existing Server
   Logically Scale up/down Existing Server
   Add a new server to a customer application
   Remove a server from a customer application
Properties
   Metrics
      Engagement: Projected Required Servers for New Engagement
      Network Bandwidth Utilization of specific server
      Average CPU Utilization (90% percentile)
   Limits
      Upper
         Physical Expandability of the Server
         Space Availability
         Unallocated Capacity (if logically scaling server
         Resource Maximum (if logically scaling the server)
         Availability of required switch ports
      Imposed
         Contractual Maximum # of Servers
         Process Convention (Never fully allocate all resources on a given server—Seasonal Growth)
         Contractual Minimum # of Servers
         Available Floor space (may not have the space for a physical addition)
         IP Address Availability (in given PoD network Infrastructure)
         Standard Spanning tree convergence time in given PoD Infrastructure
         Tivoli Gateway Capacity Availability
         Physical Server Configuration Standard (if physically scaling an existing server.

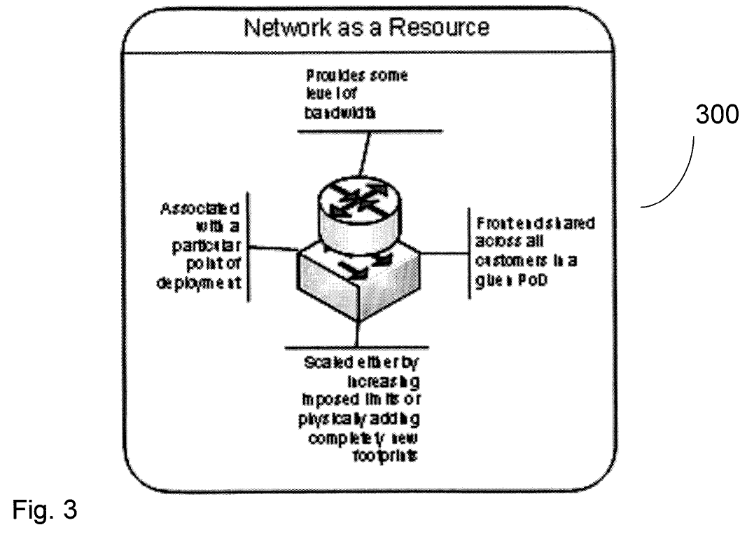

Referring to FIG. 3, shown is as a network acting a resource 300.

This is the same as the example above except with different options and properties
Operations
   Scale down allocated Bandwidth
   Scale Up Allocated Bandwidth
Properties
   Metrics
      Engagement: Projected Network Bandwidth for new engagements
      Average Bandwidth
      Network Bandwidth per Transaction
   Limits
      Upper
         Spanning Tree Convergence Time/Limit (if adding network connection)
         Available Space in the PoD (if adding network equipment)
         Available Bandwidth at PoD Level (if adding additional network bandwidth to site is required)
      Imposed
         Contractual Limit on Bandwidth allocation/Consumption (if adding or removing network capacity)
         Speed of switch port (10,100,1000)

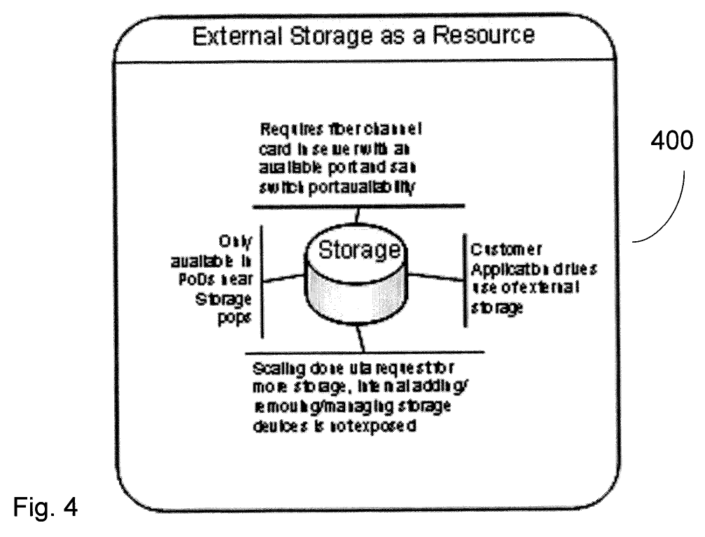

Referring to FIG. 4, shown is an external storage apparatus acting as a resource 400.
Operations
   Storage to Application
   Remove Storage from Application
Properties
   Metrics
      Engagement: Projected Storage for new equipment
      Storage usage Trend (if existing)
      Storage Availability in PoD
   Limits
      Upper
         Server Fiber Connection Available
         Available Fiber Switch Ports
         Storage Device Expandability
         Available Storage of the appropriate type
         Limit of physical location of Storage POP
      Imposed
         Contractual Limit

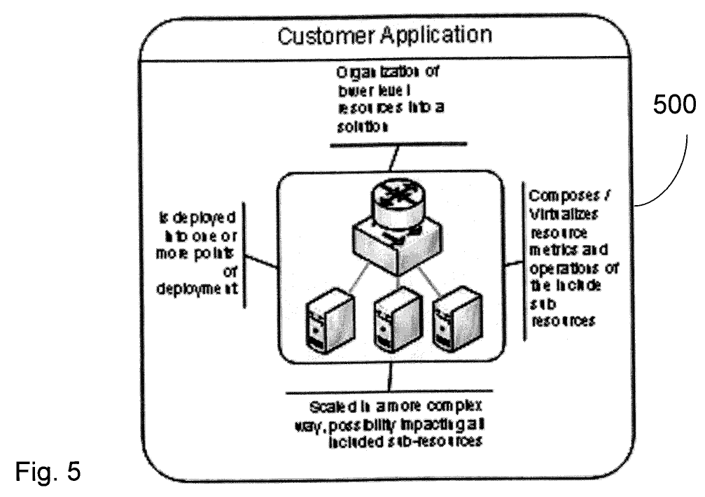

Referring to FIG. 5, shown is a customer application acting as a resource 500. As further apply this model is possible to completely abstract the managing process from the complexity of the IT system by orchestrating the operations at a more generic fashion, and moving the complexity of detailed leaf node capacity management to a lower level capacity process. In this way simple functions like, add or remove capacity can be presented as operations. These operations would be a standard orchestration of operations on lower level resources and could include the adding or removing a servers from a cluster, increasing available bandwidth, adding or removing storage, etc, all as part of a single operation on a “application” resource.
Operations
   Add Capacity
   Remove Capacity
   Modify Capacity
Operations Virtualizes lower level resources
   When capacity is added/removed to/from a customer application it may require adding network. Server and storage resources to the environment. This process is defined as the customer environment is defined.
Properties
   Metrics
      Engagement: Projected Concurrent Users
      Transaction per Second
      Concurrent Users
   Limits
      Upper
         Constrained only by POD
      Imposed
         Contractual Limits

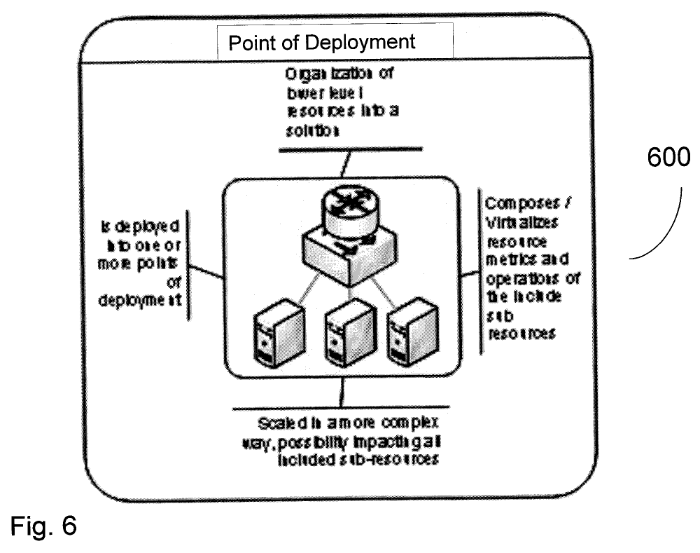

Referring to FIG. 6, shown is a point of deployment acting as a resource 600. This diagram depicts the possibility to manage a location as a resource. This location has a certain capacity for systems management, a certain floor space, network bandwidth etc, but can also be managed by a standard set of operations, metrics and limits which can be used to orchestrate capacity related workflows.
Operations
   Add Capacity
   Remove Capacity
   Modify Capacity
Operations Virtualizes lower level resources
   When capacity is added/removed to/from a customer application it may require adding network. Server and storage resources to the environment. This process is defined as the customer environment is defined.
Properties
   Metrics
      Engagement: Projected Concurrent Users
      Transaction per Second
      Concurrent Users
   Limits
      Upper
         Constrained only by POD
      Imposed
         Contractual Limits

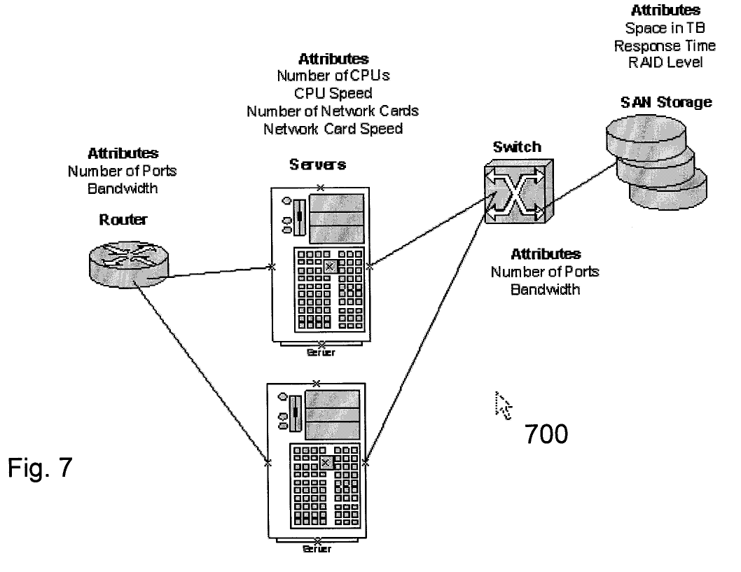

Referring to FIG. 7, shown is a usage scenario 700 according to an embodiment of the present invention.

The figure that follows describes a scenario for various resources of a data center in its physical layout. Each resource has attributes, which represent the physical limits of that resource and are referred to as the upper limits. The limits on how much the physical resources can be are specified by contracts and policies referred to as the imposed limits.

For example, the capacity of the storage can limit the size of the database of a server. Similarly, the number of ports on the switch can limit the number of server machines can be connected to it. In another word, a resource, such as a server, is limited by its own attributes as well as the attributes of the resources it depends on both upstream and downstream.
1. A server has the following attributes:
   CPU has attributes such as speed, imposing a limit on the resource that connects to
2. High speed Network Router has these attributes: bandwidth and the number of ports, which limits the number of server machines can be connect to it
3. Switch has the following attributes: number of ports, bandwidth,
4. San Storage has the following attributes:
   space(capacity) in Tera Bytes, access speed, impose limits of how much capacity a machine that connect to it can use
   RAID level—certain applications may require a specific RAID level, which may exclude the usage of certain SAN storage as a result
   Response time—certain applications may require a specific response time

Additional embodiments of the present invention will be described with reference to the following figures.

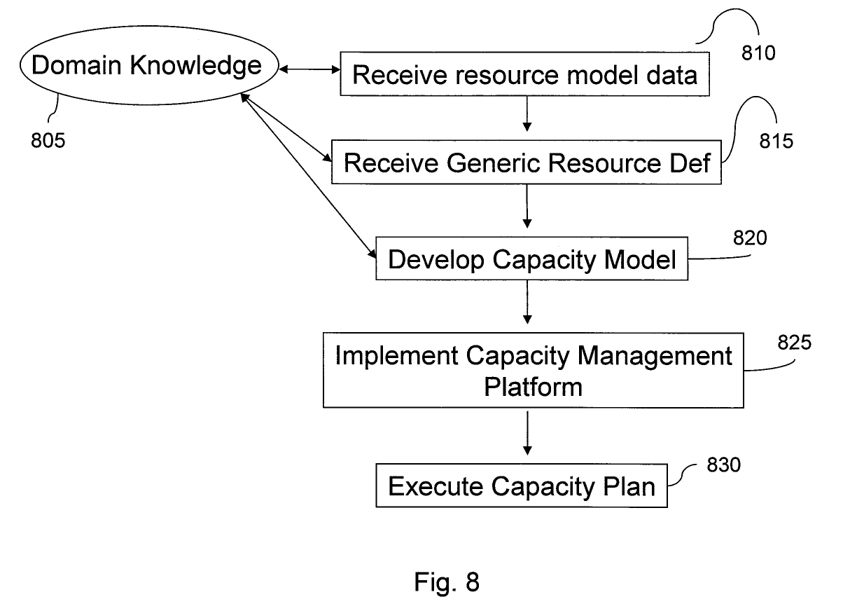

Referring to FIG. 8, shown is a flow chart according to yet another embodiment of the present invention. The steps of organizing a capacity planning system requires the inputting of resource model data 810, generic resource definitions 815, and to develop a service delivery center capacity model 820 from domain knowledge 805. The service delivery center capacity model 820 also receives data from other sources. Once the above information as been determined the system can implement the development of a capacity management platform 825 to execute a capacity plan 830 for processing the capacity management.

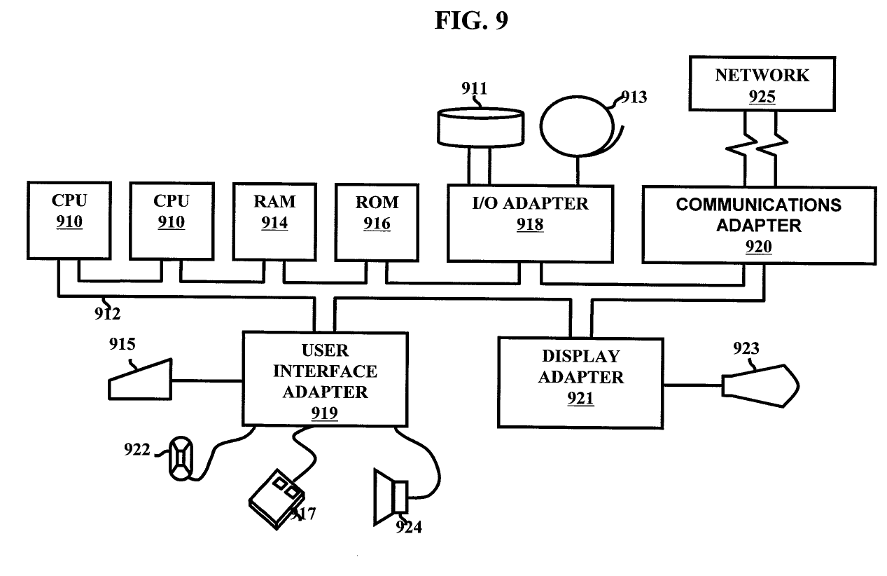

A representative hardware environment for practicing the embodiments of the invention is depicted in FIG. 9. This schematic drawing illustrates a hardware configuration of an information handling/computer system in accordance with the embodiments of the invention. The system comprises at least one processor or central processing unit (CPU) 910. The CPUs 910 are interconnected via system bus 912 to various devices such as a random access memory (RAM) 914, read-only memory (ROM) 916, and an input/output (I/O) adapter 918. The I/O adapter 918 can connect to peripheral devices, such as disk units 911 and tape drives 913, or other program storage devices that are readable by the system. The system can read the inventive instructions on the program storage devices and follow these instructions to execute the methodology of the embodiments of the invention. The system further includes a user interface adapter 919 that connects a keyboard 915, mouse 917, speaker 924, microphone 922, and/or other user interface devices such as a touch screen device (not shown) to the bus 912 to gather user input. Additionally, a communication adapter 920 connects the bus 912 to a data processing network 925, and a display adapter 921 connects the bus 912 to a display device 923, which may be embodied as an output device such as a monitor, printer, or transmitter, for example.

It should also be obvious to one of skill in the art that the instructions for the technique described herein can be downloaded through a network interface from a remote storage facility or server.

The described techniques may be implemented as a method, apparatus or article of manufacture involving software, firmware, micro-code, hardware and/or any combination thereof. The term “article of manufacture” as used herein refers to code or logic implemented in a medium, where such medium may comprise hardware logic [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, visible light signals, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made without departing from the scope of embodiments, and that the article of manufacture may comprise any information bearing medium. For example, the article of manufacture comprises a storage medium having stored therein instructions that when executed by a machine results in operations being performed.

Certain embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article. The functionality and/or the features of a device may be alternatively embodied by one or more other devices which are not explicitly described as having such functionality/features. Thus, other embodiments need not include the device itself.

Certain embodiments may be directed to a method for deploying computing instruction by a person or automated processing integrating computer-readable code into a computing system, wherein the code in combination with the computing system is enabled to perform the operations of the described embodiments.

At least certain of the operations illustrated in here in may be performed in parallel as well as sequentially. In alternative embodiments, certain of the operations may be performed in a different order, modified or removed.

Furthermore, many of the software and hardware components have been described in separate modules for purposes of illustration. Such components may be integrated into a fewer number of components or divided into a larger number of components. Additionally, certain operations described as performed by a specific component may be performed by other components.

The data structures and components shown or referred to are described as having specific types of information. In alternative embodiments, the data structures and components may be structured differently and have fewer, more or different fields or different functions than those shown or referred to in the figures.

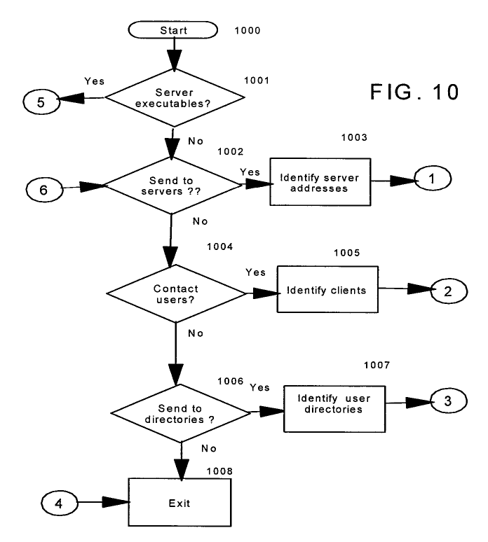

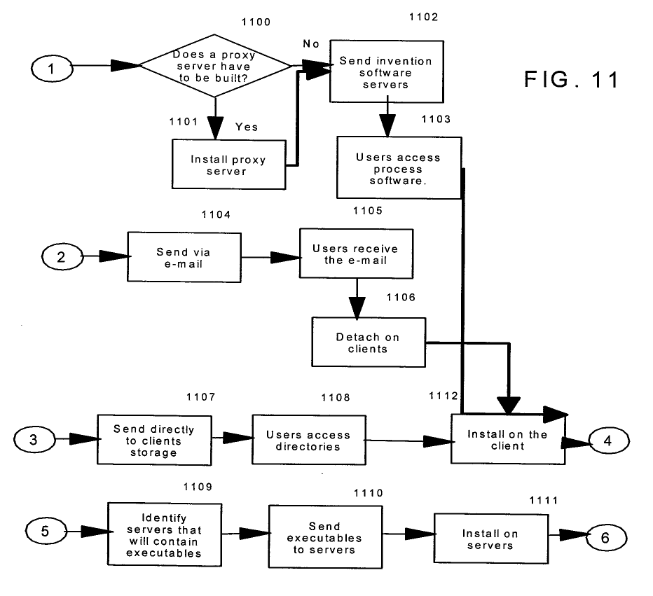

FIGS. 10 and 11 illustrate yet another software deployment implementation for using an embodiment of the present invention. Step 1000 begins the deployment of the process software. The first thing is to determine if there are any programs that will reside on a server or servers when the process software is executed 1001. If this is the case then the servers that will contain the executables are identified 1109. The process software for the server or servers is transferred directly to the servers' storage via FTP or some other protocol or by copying though the use of a shared file system 1110. The process software is then installed on the servers 1111.

Next, a determination is made on whether the process software is be deployed by having users access the process software on a server or servers 1002. If the users are to access the process software on servers then the server addresses that will store the process software are identified 1003.

A determination is made if a proxy server is to be built 1100 to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required then the proxy server is installed 1101. The process software is sent to the servers either via a protocol such as FTP or it is copied directly from the source files to the server files via file sharing 1102. Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems 1103. Another embodiment is to have the servers automatically copy the process software to each client and then run the installation program for the process software at each client computer. The user executes the program that installs the process software on his client computer 1112 then exits the process 1008.

In step 1004 a determination is made whether the process software is to be deployed by sending the process software to users via e-mail. The set of users where the process software will be deployed are identified together with the addresses of the user client computers 1005. The process software is sent via e-mail to each of the users' client computers. The users then receive the e-mail 1105 and then detach the process software from the e-mail to a directory on their client computers 1106. The user executes the program that installs the process software on his client computer 1112 then exits the process 1008.

Lastly a determination is made on whether the process software will be sent directly to user directories on their client computers 1006. If so, the user directories are identified 1007. The process software is transferred directly to the user's client computer directory 1107. This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software 1108. The user executes the program that installs the process software on his client computer 1112 then exits the process 1008.

The present software can be further deployed to third parties as part of an additional service wherein a third party VPN service is offered as a secure deployment vehicle or wherein a VPN is build on-demand as required for a specific deployment. A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a companies multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

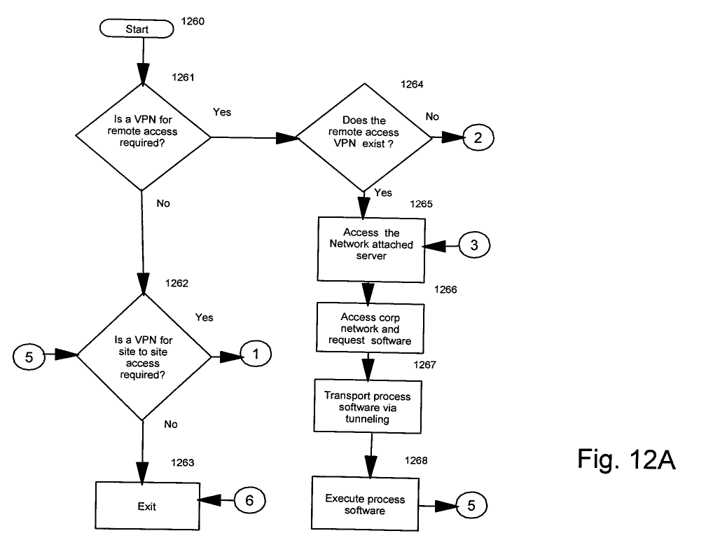

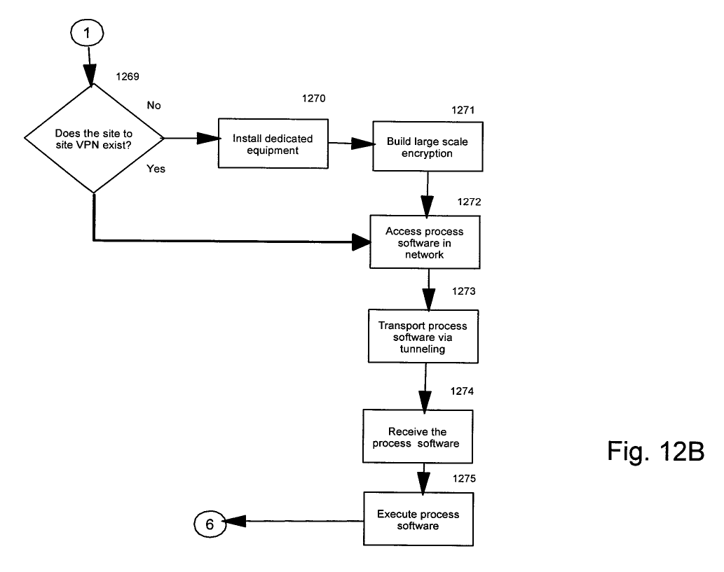

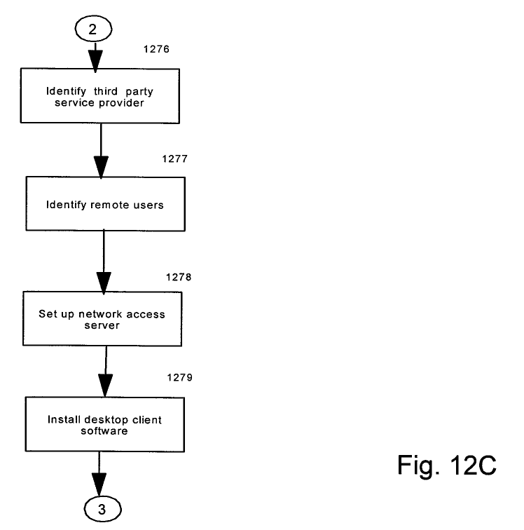

FIGS. 12A, 12B and 12C illustrate the VPN software deployment implementation for using an integrated approach in an end-to-end process according to an embodiment of the present invention. Step 1260 begins the Virtual Private Network (VPN) process. A determination is made to see if a VPN for remote access is required 1261. If it is not required, then proceed to 1262. If it is required, then determine if the remote access VPN exists 1264.

If a VPN does exist, then proceed to 1275. Otherwise identify a third party provider that will provide the secure, encrypted connections between the company's private network and the company's remote users 1276. The company's remote users are identified 1277. The third party provider then sets up a network access server (NAS) 1278 that allows the remote users to dial a toll free number or attach directly via a broadband modem to access, download and install the desktop client software for the remote-access VPN 1279.

After the remote access VPN has been built or if it been previously installed, the remote users can access the process software by dialing into the NAS or attaching directly via a cable or DSL modem into the NAS 1265. This allows entry into the corporate network where the process software is accessed 1266. The process software is transported to the remote user's desktop over the network via tunneling. That is the process software is divided into packets and each packet including the data and protocol is placed within another packet 1267. When the process software arrives at the remote user's desktop, it is removed from the packets, reconstituted and then is executed on the remote users desktop 1268.

A determination is made to see if a VPN for site to site access is required 1262. If it is not required, then proceed to exit the process 1263. Otherwise, determine if the site to site VPN exists 1269. If it does exist, then proceed to 1272. Otherwise, install the dedicated equipment required to establish a site to site VPN 1270. Then build the large scale encryption into the VPN 1271.

After the site to site VPN has been built or if it had been previously established, the users access the process software via the VPN 1272. The process software is transported to the site users over the network via tunneling. That is the process software is divided into packets and each packet including the data and protocol is placed within another packet 1274. When the process software arrives at the remote user's desktop, it is removed from the packets, reconstituted and is executed on the site users desktop 1275. Proceed to exit the process 1263.

It is to be understood that the provided illustrative examples are by no means exhaustive of the many possible uses for my invention.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the embodiments described above, but encompasses any and all embodiments within the scope of the following claims:

We claim:

1. A method for organizing a capacity planning system, comprising:
receiving resource model data from domain knowledge;
receiving generic resource definitions from said domain knowledge;
developing a service delivery center capacity model based upon said domain knowledge and other data; and
implementing capacity management platform to execute a capacity plan for processing said capacity management.

2. The method of claim 1, wherein said receiving of resource model data is data relating to a server.

3. The method of claim 1, wherein said receiving of resource model data is data relating to a network.

4. The method of claim 1, wherein said receiving of resource model data is data relating to a storage apparatus.

5. The method of claim 1, wherein said receiving of resource model data is data relating to a customer application.

6. The method of claim 1, wherein said receiving of resource model data is data relating to a point of deployment for services.

7. The method of claim 1, wherein said receiving of resource definitions is metrics data relating said resource model.

8. The method of claim 8, further comprises:
tying said metrics data to the business function of said resource model.

9. The method of claim 1, further comprises:
imposing limits on said resource model.

10. The method of claim 9, wherein said imposing of limits define an upper limit for said resource model.

11. The method of claim 9, wherein said imposing of limits define an imposed limit for said resource model.

12. A computer-based method for an electronic service offering, comprising:
receiving resource model data from domain knowledge;
receiving generic resource definitions from said domain knowledge;
developing a service delivery center capacity model based upon said domain knowledge and other data; and
implementing capacity management platform to execute a capacity plan for processing said capacity management.

13. The method of claim 12, wherein said receiving of resource model data is data relating to a server.

14. The method of claim 12, wherein said receiving of resource model data is data relating to a customer application.

15. Apparatus for organizing a capacity planning system, the apparatus comprising:
at least one computer being configured to be operative to; receive resource model data from domain knowledge, receive generic resource definitions from said domain knowledge, develop a service delivery center capacity model based upon said domain knowledge and other data, and implement a capacity management platform to execute a capacity plan for processing said capacity management.

16. The apparatus of claim 15, wherein said received resource model data is data from a server.

17. The apparatus of claim 15, wherein said received resource model data is data from a network.

18. The apparatus of claim 15, wherein said received resource model data is data from a storage apparatus.

19. The apparatus of claim 1, wherein said received resource model data is data from a customer application running on a computer device.

20. A program storage device readable by a machine, tangibly embodying a program of instructions executable by the machine to perform a method comprising:
receiving resource model data from domain knowledge;
receiving generic resource definitions from said domain knowledge;
developing a service delivery center capacity model based upon said domain knowledge and other data; and
implementing capacity management platform to execute a capacity plan for processing said capacity management.
